(19) United States
(12) Patent Application Publication
(10) Pub. No.: US 2010/0210345 A1
(43) Pub. Date: Aug. 19, 2010

(54) System, Apparatus, and Method for Facilitating Secondary Winning Events in Conjunction with a Primary Gaming Activity

(76) Inventors: Bradley Berman, Minnetonka, MN (US); Chad Shapiro, Plymouth, MN (US)

Correspondence Address: Hollingsworth & Funk, LLC, Suite 320, 8500 Normandale Lake Blvd., Minneapolis, MN, 55437, US

(21) Appl. No.: 12/706,674

(22) Filed: Feb. 16, 2010

Related U.S. Application Data
(60) Provisional application No. 61/153,045, filed on Feb. 17, 2009.

(51) Int. Cl. A63F 9/24; A63F 13/00

(52) U.S. Cl. 463/20; 463/25; 463/43; 463/30

(57) ABSTRACT

A plurality of events associated with the primary gaming activity of a gaming machine is detected. In response to the events, a dynamic symbol is generated having a value that is independent of the respective primary gaming event. A monetary award is provided to the player based on a value of at least one of the dynamic symbols meeting a predetermined criterion. The provision of the monetary award is determined independently of outcomes of the events of the primary gaming activity.

### RELATED APPLICATIONS

This application claims the benefit of Provisional Patent Application Ser. No. 61/153,045, filed on Feb. 17, 2009, to which priority is claimed pursuant to 35 U.S.C. §119(e) and which is hereby incorporated herein by reference in its entirety.

### FIELD OF THE INVENTION

This invention relates in general to games, and more particularly to apparatuses and methods for facilitating independent winning events in conjunction with a primary gaming activity.

### BACKGROUND

Casino games such as poker, slots, and craps have long been enjoyed as a means of entertainment. Almost any game that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Gaming manufacturers and operators are striving to provide ever more varied and interesting experiences for gamers. For casino games in particular, the prospect of getting payouts based on a wide variety of possibilities is attractive to gamers. The programmable nature of computerized gaming machines make adding of additional features relatively easy and inexpensive. The present disclosure describes ways of providing an enhanced gaming experience that can be added to existing games, and provides other advantages over the prior art.

### SUMMARY

To overcome limitations in the prior art described above, and to overcome other limitations that will become apparent upon reading and understanding the present specification, the apparatuses, systems, and methods are disclosed for providing secondary gaming experiences to a player. In one embodiment, a method involves detecting a plurality of events associated with a primary gaming activity of a gaming machine. In response to each of the events, a dynamic symbol is generated having a value that is independent of the respective primary gaming event. A monetary award is provided to the player based on a value of at least one of the dynamic symbols meeting a predetermined criterion. The provision of the monetary award is determined independently of outcomes of the events of the primary gaming activity.

In accordance with one embodiment, a method is provided that includes detecting a plurality of events associated with a primary gaming activity of a gaming machine, generating, in response to at least one of the events, a dynamic symbol having a value that is independent of the respective primary gaming event, and providing a monetary award to the player based on a value of at least one of the dynamic symbols meeting a predetermined criterion, wherein the provision of the monetary award is determined independently of outcomes of the events of the primary gaming activity.

Another more specific embodiment of such a method include rendering, during the plurality of events, a fixed symbol uniquely associated with the gaming machine, and wherein providing the monetary award is based on comparing the at least one of the dynamic symbols with the fixed symbol. In yet another embodiment, the comparison of the at least one of the dynamic symbols with the fixed symbol involves determining matching values of individual elements of the at least one of the dynamic symbols with individual elements of the fixed symbol. In still another embodiment, the comparison of the at least one of the dynamic symbols with the fixed symbol involves determining matching sequences of the individual elements of the at least one of the dynamic symbols with sequences of the individual elements of the fixed symbol. In another embodiment, providing the monetary award to the player involves determining two or more potential awards associated with the comparison of the at least one dynamic symbol with the fixed symbol, where values of the two or more projected awards are determined based on degrees of similarity between the at least one dynamic symbol and the fixed symbol. In yet another embodiment, a value of the fixed symbol is changed based on the provision of the monetary award to the player. In still another embodiment, the value of the fixed symbol is set based on an identity of the player.

In another embodiment, the method further involves rendering a value of a projected monetary award associated with the value of the at least one of the dynamic symbols meeting the predetermined criterion. Another embodiment further involves incrementing the value of the projected monetary award based on successive events that result in no monetary awards being provided to the player. Another embodiment of the method includes determining the value of the monetary award based on the number of successive events that result in no monetary awards being provided to the player. In yet another embodiment, the method involves generating the dynamic symbol in response to at least one of the events by generating portions of the dynamic symbol in response subsequently occurring events of the primary gaming activity, where determining whether the at least one of the dynamic symbols meets the predetermined criterion occurs after a sufficient number of the subsequently occurring events have taken place in order to form the at least one dynamic symbol.

According to another embodiment, a method is provided that includes uniquely associating each of the gaming machines with a fixed symbol, and determining a group symbol based on the fixed symbols of the gaming machines. For each of the gaming machines, this method embodiment involves detecting events associated with the primary gaming activity of the gaming machine, generating, in response at least one of the events, a dynamic symbol having a value that is independent of the respective event, and providing a monetary award to the player of the gaming machine based on a comparison of one of the dynamic symbols with the group symbol, where the provision of the monetary award is determined independently of outcomes of the primary gaming activity of the machine.

In accordance with more particular embodiments of such a method, the method further includes, for each of the gaming machines, providing a monetary award to the player of the gaming machine based on a value of one of the dynamic symbols meeting a predetermined criterion. In another particular embodiment, for at least one of the gaming machines, providing the monetary award based on the value of one of the dynamic symbol involves providing the monetary award based comparing one of the dynamic symbols with the fixed symbol uniquely associated with the at least one gaming machine. In yet another embodiment, uniquely associating each of the gaming machines with a fixed symbol involves setting the value of the fixed symbol for each machine based on an identity of the player of each machine.

In accordance with another embodiment of the invention, a casino gaming apparatus includes a processor, an input and output coupled to the processor, and a primary gaming module that causes the processor to provide player access to a primary gaming activity via the input and output. A secondary gaming module causes the processor to generate, in response to a plurality of events of the primary gaming activity, a dynamic symbol having a value that is independent of the respective event, render the dynamic symbols via the input and output, determine a secondary winning event based the value of one of the dynamic symbols meeting a predetermined criterion, wherein the secondary winning event is independent of outcomes of the primary gaming activity, and provide a monetary award to the player based on the secondary winning event.

In a more particular embodiment of such an apparatus, the secondary gaming module further causes the processor to generate a fixed symbol uniquely associated with the apparatus, render the fixed symbol via the human input and output, where the predetermined criterion of the secondary gaming module comprises a comparison of the fixed symbol with the one of the dynamic symbols. In a more particular embodiment, the predetermined criterion includes matching values of individual elements of one of the dynamic symbols with individual elements of the fixed symbol. In another embodiment, the predetermined criterion includes matching sequences of the individual elements of one of the dynamic symbols with sequences of the individual elements of the fixed symbol. In yet another embodiment, the secondary gaming module causes the processor to change a value of the fixed symbol based on the provision of the monetary award to the player. Another embodiment involves a player identity module that causes the processor to detect an identity of a player, and further causes the secondary gaming module to set a value of the fixed symbol based on the identity of the player.

In other particular embodiments of such an apparatus, the secondary gaming module causes the rendering device to render a projected value of the monetary award. In a more particular embodiment, the secondary gaming module causes the rendering device to increment the projected value of the monetary based on successive events of the primary gaming activity during which no secondary winning events are determined by the secondary gaming module.

In another embodiment of such an apparatus, the secondary gaming module causes the processor to generate portions of the dynamic symbol in response subsequently occurring events of the primary gaming activity, and determine whether the at least one of the dynamic symbols meets the predetermined criterion occurs after a sufficient number of the subsequently occurring events have taken place in order to form the at least one dynamic symbol.

In another embodiment, a computer-readable medium, including any temporary or permanent storage device/medium, includes computer-executable instructions stored thereon that are executable by a processing system for performing a method including detecting a plurality of events associated with a primary gaming activity of a gaming machine, generating, in response to the events, a dynamic symbol having a value that is independent of the respective primary gaming event, and providing a monetary award to the player based on a value of at least one of the dynamic symbols meeting a predetermined criterion, where the provision of the monetary award is determined independently of outcomes of the events of the primary gaming activity. Other more particular embodiments further include rendering, during the plurality of events, a fixed symbol uniquely associated with the gaming machine, where providing the monetary award is based on comparing the at least one of the dynamic symbols with the fixed symbol. In another particular embodiment, the instructions may further cause the value of the fixed symbol to be set based on an identity of the player.

In accordance with another embodiment of the invention, a system is provided that includes at least a plurality of gaming machines each uniquely associated with a fixed symbol, where each of the gaming machines includes a human input and output capable of providing player access to a primary gaming activity of the machine, a processor coupled to the human input and output, a primary gaming module that causes the processor to facilitate, via the human input and output, player interaction with the primary gaming activity, and a secondary gaming module that causes the processor to generate, in response to at least one of a plurality of events of the primary gaming activity, a dynamic symbol that is independent of the respective event. A group display apparatus is coupled to the plurality of gaming machines, and includes a display, a processor coupled to the display; a memory having instructions that cause the processor to form a group symbol based on the fixed symbols of the plurality of gaming machines and display the group symbol via the display. The exemplary system is further configured to provide a monetary award to a player of a gaming machine selected from the plurality of gaming machines based on a comparison of one of the dynamic symbols of the selected gaming machine with the group symbol.

In another more particular embodiment of such a system, the secondary gaming modules of at least one of the gaming machines cause the processor of the at least one gaming machine to determine a secondary winning event based the value of one of the dynamic symbols that meets a predetermined criterion, wherein the secondary winning event is independent of outcomes of the primary gaming events, and to provide a local monetary award to the player based on the secondary winning event, where a value of the local monetary award is determined independently of awards associated with the primary gaming activity of the at least one gaming machine. In yet another particular embodiment, the fixed symbols of the plurality of gaming machines are uniquely associated with the each gaming machine based on the identity of the player of each gaming machine.

### BRIEF DESCRIPTION OF THE DRAWINGS

The invention is described in connection with the embodiments illustrated in the following diagrams.

FIG. 1. is a flow diagram illustrating a manner of providing an award using a secondary gaming activity that is independent of a primary gaming activity in accordance with one embodiment of the present invention;

FIG. 2 is a block diagram of a gaming machine according to an embodiment of the invention;

FIG. 3 is a block diagram of a gaming machine according to another embodiment of the invention;

FIGS. 4A-4H are block diagrams illustrating configurations of fixed and dynamic symbols according to embodiments of the invention;

FIG. 5 is a flow diagram illustrating a manner of displaying a fixed symbol associated with a gaming machine according to an embodiment of the present invention;

FIG. 6 is a block diagram of user interaction with a gaming machine according to another embodiment of the invention;

FIG. 7 is a flow diagram illustrating a manner of providing a group award using secondary gaming activities that are independent of primary gaming activities according to an embodiment of the present invention;

FIG. 8 is a block diagram illustrating an example of forming a group symbol according to an embodiment of the invention;

FIG. 9 is a block diagram of a processor-implemented gaming machine according to an embodiment of the present invention;

FIG. 10 is a block diagram of a gaming system according to an embodiment of the present invention; and

FIG. 11 is a block diagram illustrating software component interactions according to an embodiment of the invention.

### DETAILED DESCRIPTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to providing a secondary winning opportunity associated with events of a primary gaming activity. The secondary winning opportunities may be triggered off of events of the primary gaming activity, even though the secondary winning opportunity may be otherwise independent of the primary game. The activities are typically independent both in terms of the decision to provide an award and the amount of payoffs associated with the award. For example, the primary and secondary activities may have unique and different criteria to determine whether any given event results in a payout, and those criteria may be independent from each other. Similarly, the amount of payouts as determined by pay tables, multipliers, etc., are also independently determined for the primary and secondary activities. In this way, the player has another factor of interest associated with each gaming event of the primary gaming activity, and the player is afforded another chance to win by way of the secondary activity, even if the player loses at the primary activity.

The present invention is independent of the form of the primary gaming activities. For example the concepts described herein may be applied to any wagering or non-wagering game known in the art, including slots, poker, blackjack, roulette, keno, craps, baccarat, sports betting, etc. The present invention may be applicable to mechanized and non-mechanized versions of these primary games. Embodiments of the present invention may be described in the context of computerized gaming apparatus, although those skilled in the art will recognize the concepts may be applicable to non-computerized and non-mechanized equivalents.

In various embodiments of the invention, the secondary activity is described in conjunction with the use of data in the form of “symbols.” In the context of this disclosure, a “symbol” refers to a collection of one or more arbitrary indicia or signs that have some conventional significance. In particular, the symbol may represent values that can at least be used to determine whether to award a payout. A symbol may include a collection of numbers, letters, shapes, pictures, textures, colors, sounds, etc., and any combination therebetween. A win can be determined for a symbol either based on the contents of the symbol itself, or by comparing the symbol with another symbol. Generally, such comparisons can be performed via software by mapping numbers (or other data structures such as character strings) to the symbols and performing the comparisons on the numbers/data structures.

In some arrangements, a symbol that satisfies a certain predetermined criterion (e.g., a pattern of some number of consecutive or non-consecutive matching elements) can be determinative of a win on its own, without comparison to some other symbol. For instance, the number “58883” may be a winner because of the three consecutive eights, or the number “58838” may be a winner because of three non-consecutive eights. Other examples of self-determinative symbol combinations may include numbers that combine to a resultant value that satisfies some numerical limit, shapes that interlock to form a resultant shape (e.g., similar to jigsaw puzzle pieces), a symbol having no duplicate elements, a symbol whose elements form a particular pattern, etc.

In other embodiments, the symbol is compared to another, fixed symbol to determine a win. The fixed, or static symbol, may be used for any number of consecutive play events. The symbol is considered “fixed” at least in comparison to a series of dynamic symbols generated for each play event. Typically, a new dynamic symbol is generated for each play event, and compared to the fixed symbol, which itself remains constant for some number of play events. The comparison may require exact matches of sequential symbol elements, or any match of symbol elements, whether the sequence is the same or not. For example, if the fixed symbol is “8998,” an exact match comparison would require a dynamic symbol to contain at least “8998” in order to win. Where an exact sequential match is not required, some other combination such as “9898” may suffice to win. A winning event might also be determined if the dynamic symbol matches a subset of the fixed symbol. For example, again assuming a fixed symbol of “8998,” winning symbols might include “899” or “1899” if a sequential match is required, and “989” or “9819” if a sequential match is not required. Generally, the present invention may be applicable to symbols have the same or different lengths, and the comparisons may be applied to all or part of either the fixed or dynamic symbols.

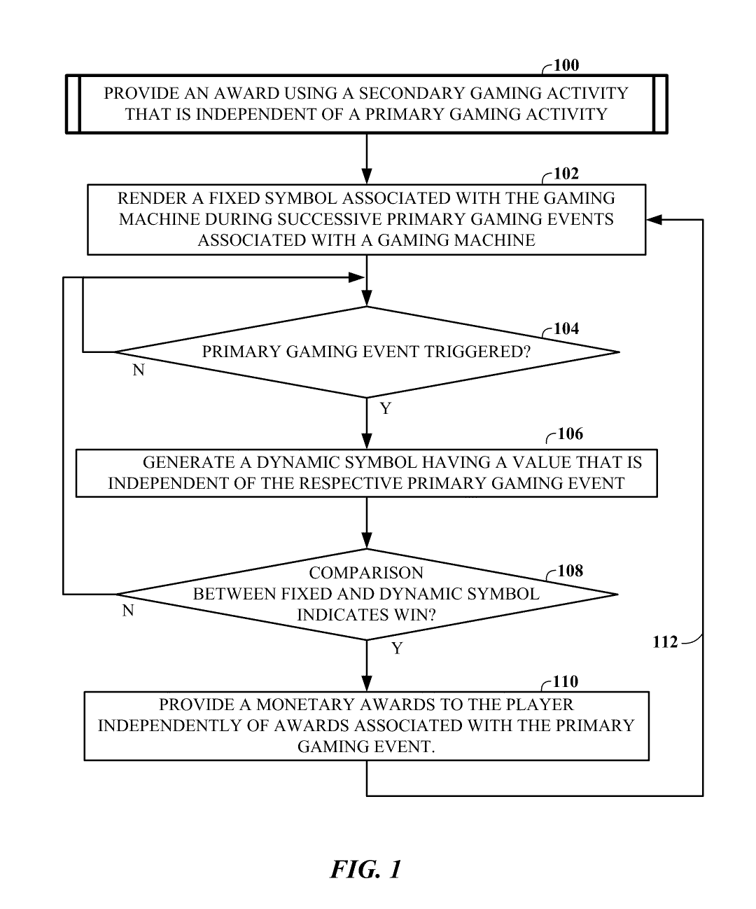

In reference now to FIG. 1, a flow diagram illustrates an example procedure 100 for providing a gaming award using a secondary gaming activity that is independent of a primary gaming activity. The secondary gaming activity may be played on the same apparatus as the primary gaming activities. The primary and secondary activities may be distributed on a number of devices as well, although the player may be presented with indications that the secondary activity is associated with the primary gaming activity. This may include, for example, placing two or more devices in the same case, adding visual elements (e.g., signs, graphics) that link the multiple devices, etc. Both the primary and secondary gaming activities may be realized, in whole or in part, on a processor-implemented gaming apparatus. As such, the activities are usually implemented as computer executable instructions, such as binary objects, scripts, etc. However, the gaming apparatus may include mechanical and electromechanical components for providing player interactivity and for determining winning events.

Generally, a fixed symbol is associated with a gaming machine and rendered (e.g., displayed) 102 on the gaming machine during successive events related to the primary gaming activity. Although the fixed symbol may be “fixed” for some number of primary gaming events, the game designer can choose to have the fixed symbol changed at some predetermined or random time interval and/or upon the happening of some event. For example, the fixed symbol may remain constant until somebody matches it. The fixed symbol may be regenerated every time a player comes out of a bonus, when bonus picks are made, each time a free reel spin is played, etc. Alternatively, the fixed symbol may be changed periodically, e.g., daily, weekly.

The procedure 100 further involves detecting 104 primary gaming event triggers and reacting to those events. The gaming events that are detected 104 may include rolls, plays, hands, or any other combination of user- and machine-initiated events. Upon the detection 104 of the primary gaming event, a dynamic symbol is generated 106. The value of the dynamic symbol is typically generated 106 independently of values associated with the primary gaming event, so that the user may also experience some anticipation and excitement as to the outcome of secondary event that is separate and distinct from the primary gaming event.

In the illustrated procedure 100, a comparison 108 is carried out to compare the fixed symbol with the dynamically generated symbol. The comparison 108 may involve comparing some portion of the fixed symbol against some portion of the dynamic symbol. The comparison 108 may require that individual elements of the symbols match, as well as the sequence of those elements. The game designer can implement any combination of symbol size and symbol elements in order to tailor the winning odds as desired. In some embodiments, the payoff odds of the secondary gaming event are lower than the primary gaming activity. In this way, the primary activity is still the focus for attracting game play, because the primary activity is more likely to produce a win. However, the use of the symbols in providing secondary win possibilities can generate long-term interest in using a collection of gaming machines that incorporate this feature. Also, in some embodiments discussed in greater detail below, a set of fixed symbols can be carried across a number of machines so that the player can continue to be given opportunities to win based on a particular set of fixed symbols.

If the comparison 108 determines that an award is in order, the player is awarded 110 independently of the primary gaming event. This independence of the award 110 may be indicated through the use of a different award display, alternate payout hardware or methods, etc. The independence may also be extended to the use of different pay tables, multipliers, and other aspects that tend to increase or decrease a given award. Although the pay out associated with the symbols is independent of the primary event, it still may include multipliers or progressive features that change in conjunction with secondary play events of the particular machine, or of activities of other players using other machines having similar secondary play features as the particular machine. Note that a comparison 108 that results in an award 110 may involve the generation of a new fixed symbol, as indicated by path 112.

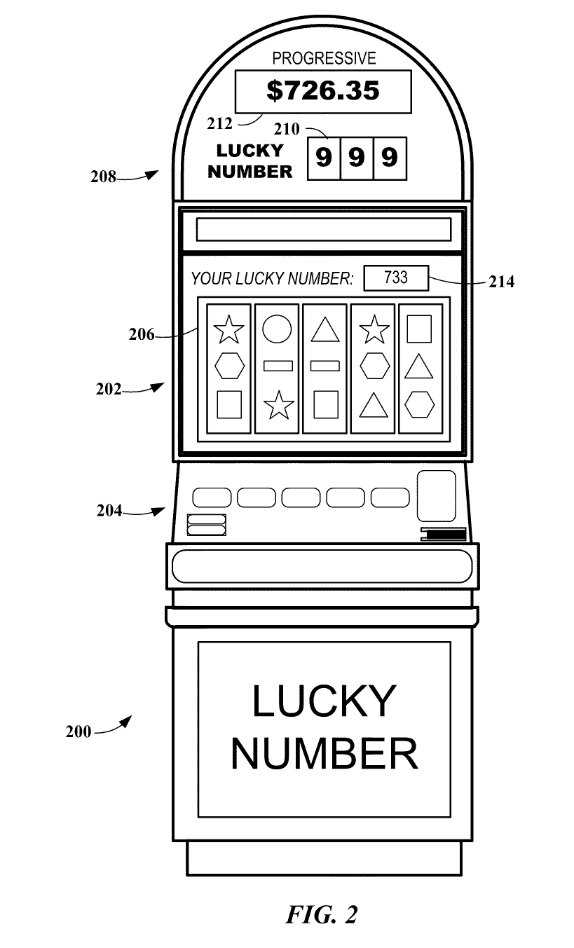

In reference now to FIG. 2, a gaming machine 200 is illustrated that provides secondary gaming experiences according to an embodiment of the invention. The illustrated gaming machine 200 may include a computing system (not shown) to carry out operations according described herein. The gaming machine 200 includes a display 202, and a user interface 204, although some or all of the user interface may be provided via the display 202 in touch screen embodiments. The user interface 204 allows the user to control and engage in play of the gaming machine 200. The particular user interface mechanisms included with user interface 204 may be dependent on the type of gaming machine. For example, the user interface 204 may include one or more buttons, switches, joysticks, levers, pull-down handles, trackballs, voice-activated input, or any other user input system or mechanism that allows the user to play the particular gaming activity.

In the particular embodiments illustrated, the gaming machine 200 may support one or more primary games 206 playable from the same machine 200. If the machine 200 supports multiple primary games 206, the user interface 204 may be generalized and programmable to support the different games. For example, various controls of the user interface 204 may have different functions depending on the current game being played. These different functions could be indicated by a menu or labels provided on the display 202, wherein the labels describe the function performed by each control for the current game. In other arrangements, the user interface 204 itself may have mechanical or electrical elements that denote different functions of various controls for each game. For example, buttons may have built-in or nearby electronic (e.g., LED, LCD) or mechanical indicators that provide words or symbols that changeably indicate the function of each button.

The user interface 204 may allow the user to enter coins, bills, or otherwise obtain credits through vouchers, tokens, credit cards, tickets, etc. Various mechanisms for entering such vouchers, tokens, credit cards, coins, tickets, etc. are known in the art. For example, coin/symbol input mechanisms, card readers, credit card readers, smart card readers, punch card readers, radio frequency identifier (RFID) readers, and other mechanisms may be used to enter wagers. It is through the user interface 204 that the user can initiate and engage in a gaming activity in accordance with the invention. While the illustrated embodiment depicts various buttons for the user interface 204, it should be recognized that a wide variety of user interface options are available for use in connection with the present invention, including pressing buttons, touching a segment of a touch-screen, entering text, entering voice commands, or other known data entry methodology.

The display device 202 may include one or more of an electronic display, a mechanical display, and fixed display information such as information such as paytable information associated with a glass/plastic panel on the gaming machine 200. The cards or other indicia associated with the play of the game may be presented on an electronic display device. Generally, the display 202 devotes the largest portion of viewable area to the primary gaming portion 206. The gaming portion 206 is generally where the visual feedback for any selected game is provided to the user. The gaming portion 206 may render graphical objects such as cards, slot wheels, dice, animated characters, and any other gaming visual known in the art. The gaming portion 206 also informs players of the outcome of any particular event, including whether the event resulted in a win or loss.

The machine 200 and its associated display 202 may also include elements that facilitate a secondary gaming activity. The illustrated machine 200 includes a symbol display area 208 that provides a relatively static indication of the fixed symbol 210 associated with this machine. In this case, the symbol 210 is a three-digit, “lucky number.” Also indicated in the symbol display area 208 is a projected payout indicator 212. The projected payout indicator 212 may be adjustable on a per-play basis, e.g., changing for each non-winning event of the primary game 206. The payout indicator 212 may also be constant, or be modified based on some other event besides play events, including time, location, player identity, etc., although the value shown in the payout indicator 212 is generally independent of the primary gaming activity 206.

The value of the lucky number 210 may remain constant for a number of events of the primary game 206. During plays of the primary game 206, a dynamic symbol 214 is shown that changes in response to primary play events. The dynamic symbol 214 may integrated into the primary display device 202 as shown, or may be part of some other display or rendering hardware. Generally, during events of the primary game 206, the dynamic symbol 214 may be compared against the fixed symbol 210 to determine whether there is a match, and therefore whether the player receives an award. The match that determines the award may be a sequential or non-sequential matching of elements within the fixed and dynamic symbols 210, 214. The award may be monetary or non-monetary, and the award is generally independent of whether the player won or lost the associated event of the primary gaming activity 206.

The dynamic symbol 214 may be generated in response to any combination of primary game events. The dynamic symbol 214 may be regenerated for every play (e.g., spin of slot wheels or hand of a card game), each time a player comes out of a bonus, when bonus picks are made, each time a free reel spin is played, etc. The dynamic symbol 214 may be generated by combinations of playing events. For example, one part (e.g., digit) of the dynamic symbol 214 may be generated for every play event, such that the comparison with the fixed symbol 210 only occurs after a predetermined number of primary and/or bonus gaming events.

As stated above, the fixed symbol 210 is relatively static. However, it may be desirable to have the value of the fixed symbol 210 change at the happening of some predetermined event. For example, the symbol value 210 might automatically change when a player wins based on a comparison of symbols 210, 214. In other arrangements, the fixed symbol 210 may be formed based on the current date, time of day, or any combination thereof. In this latter arrangement, the fixed symbol 210 will typically change with the passage of time. The fixed symbol 210 may be generated, displayed, and changed using conventional computer display technologies (e.g., CRT, LED, LCD), mechanical displays, or other rendering technologies known in the art.

The fixed symbol 210 may also be displayed and changed using apparatus that provide user interest or enforce a theme. For example, the fixed symbol 210 could be determined using ping-pong-sized balls that are randomly thrown into successive slots, thereby imitating the selection of numbers in a lottery. Other mechanical elements could also be used to create the display, including flip cards, dice, spinning wheels, etc. It will be appreciated that where a mechanical element is used to automatically form the symbol display, associated data acquisition circuitry may be used to determine the value of the resulting fixed symbol 210, at least for purposes of digitally comparing the fixed symbol value 210 to the dynamic symbol 214 by a processor. Although the illustrated embodiments show fixed and dynamic symbols 210, 214 that are displayed, any combination of human perceptible signals may be used to render the signals, including sound, touch (e.g., Braille rendering hardware), etc.

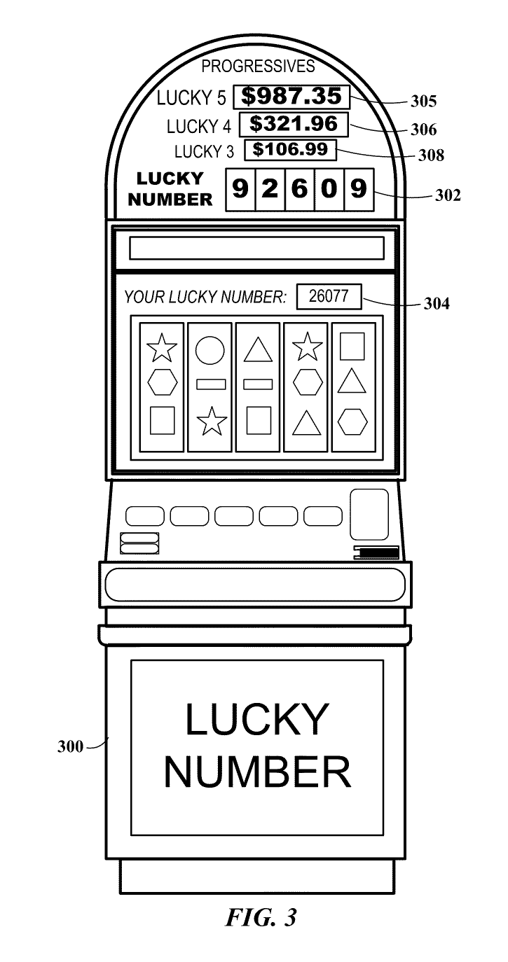

In the illustrated gaming machine 200, a match between the dynamic and fixed symbols 214, 210 results in a payout, the value of which is shown in indicator 212. In this example, a single payout is provided based on a predetermined criterion used to match the dynamic and fixed symbols 214, 210. In reference now to FIG. 3, an alternate arrangement of a gaming machine 300 is illustrated that may provide for progressive payouts according to embodiments of the present invention. The gaming machine 300 may include primary gaming activity hardware and software similar to that described in relation to FIG. 2. In this example, a fixed symbol 302 and dynamic symbol 304 include five-digit numbers. Even where there is not an exact match between the fixed and dynamic symbols 302, 304, some subset of the symbols may still have a match. This is indicated by the progressive payout indicators 305, 306, and 308, which respectively show payouts associated with matching (either sequentially or non-sequentially, depending on predetermined game rules) five, four, and five numbers between the fixed and dynamic symbols 302, 304. In the illustrated example, there is a matching sequence of the three number sequence “260” between the fixed and dynamic symbols 302, 304, therefore the player will win the amount shown in indicator 308.

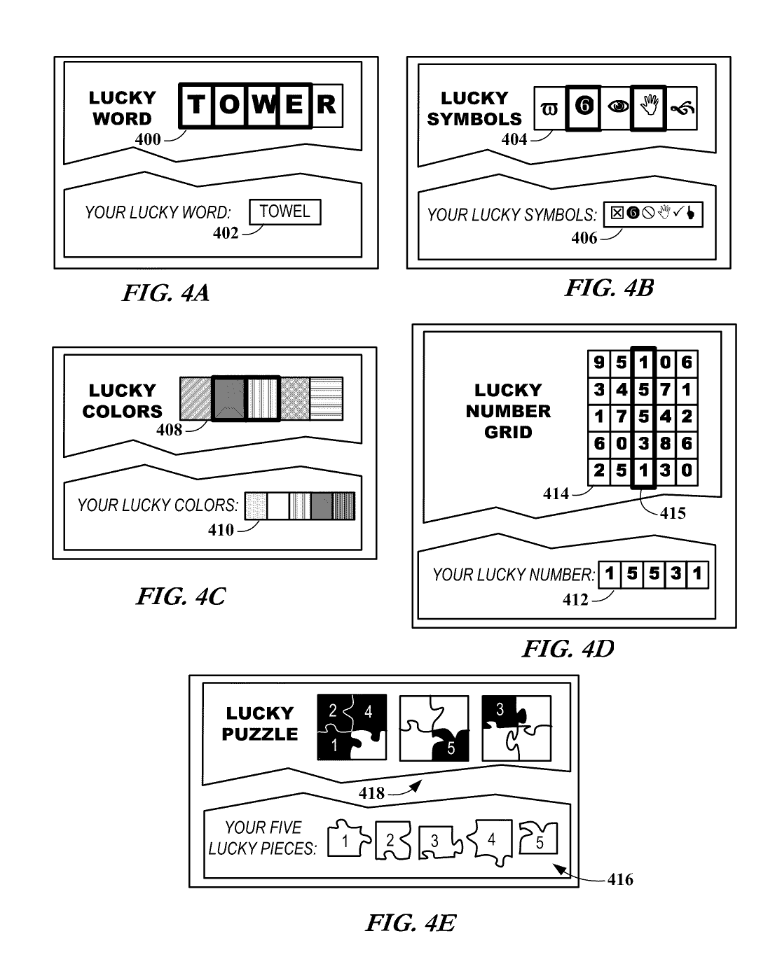

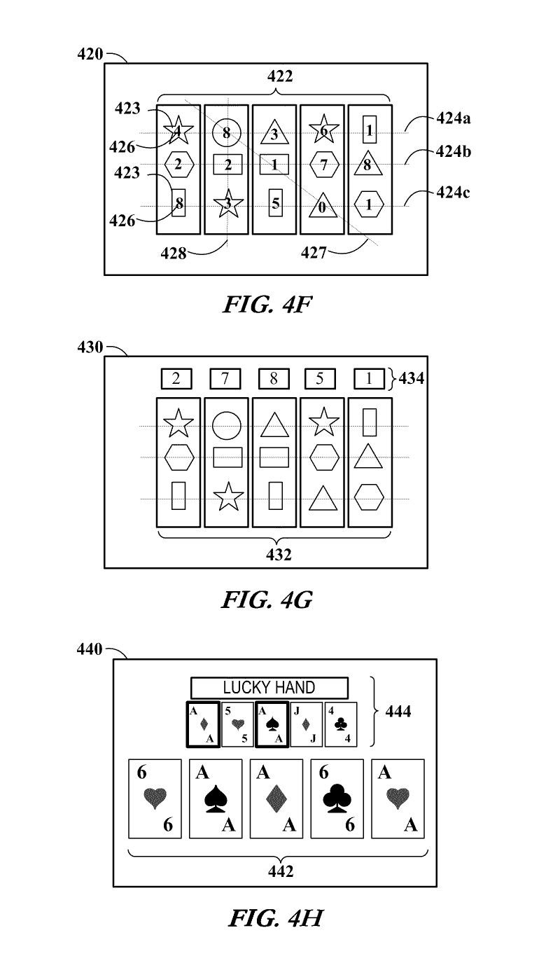

The examples in FIGS. 2 and 3 both show fixed and dynamic symbols that are formed of numerals. Many alternate types of symbols may be used according to embodiments of the invention, as is shown in FIGS. 4A-4E. In FIG. 4A a fixed symbol 400 and dynamic symbol 402 are formed using dictionary words. As seen here, a partial match of the sequence “TOWE” has resulted. In some arrangements, the letters need not form words, but may simply be randomly placed letters. In FIG. 4B, fixed symbol 404 and dynamic symbol 406 are formed using sequences of arbitrary graphical elements. This may be considered a generic configuration of dynamic and fixed symbols, because numbers and words may also be considered collections of graphical elements, e.g., digits and letters. In FIG. 4C, the fixed and dynamic symbols 408, 410 are represented as collections of squares having different colors, where each type of hatching in the illustration is used to represent a unique color. In other arrangements, patterns, hatching, textures, and other non-symbolic indicia may be used in a manner similar to FIG. 4C.

In FIG. 4D, a dynamic symbol 412 represents a one-dimensional sequence of numbers (or any other graphical element), and the fixed symbol 414 represents a two-dimensional array of elements from which a match may be determined. This provides greater possibilities of matches occurring between the dynamic and fixed symbols 412, 414, as indicated by vertical matching line 415. It will be appreciated that the fixed symbol 414 may be extended into additional dimensions (e.g., as a solid in three-dimensional space), such that any one- or two-dimensional path through the fixed symbol 414 results in a payout.

In an alternate arrangement of FIG. 4D, the number/symbol 412 may be fixed, and the grid 414 may include randomly generated, dynamic numbers/symbols. In this arrangement, each time the numbers in the grid 414 are regenerated, the values of the grid 414 are hidden, and the player has the opportunity to select one or more patterns (e.g., line 415) in trying to match the lucky number 412. The selection of patterns 415 may occur after each play, during bonus rounds, or at any other appropriate time during game play.

Although the previous examples use symbols, colors, or numbers in matching, other variations may be possible. In FIG. 4E, the dynamic symbols 416 are represented as shapes resembling a jigsaw puzzle. A results display 418 illustrates how the dynamic symbols 416 “fit” together, such that a win might be determined if four interlocking symbols 416 fit together to complete one puzzle. The example of FIG. 4E also illustrates a configuration where a comparison with a fixed symbol need not be undertaken. Although the results area 418 helps the player visualize whether he or she has won, the outcome may be determined based on the shapes of the symbols 416 themselves, and not on any comparison with a fixed symbol.

In the previous examples, the fixed symbols are generated in a display area that is separate from the primary gaming activity. For example, display of dynamic symbol 214 in FIG. 2 is separate from game play area 206. However, in cases where the payout based on the symbols is independent of the primary game, the generation of symbols need not be separated from the primary gaming area. In reference now to FIG. 4F, a primary game play area 420 according to an embodiment of the invention shows reels 422 that may correspond to a mechanical or video slot machine. Primary payout is based on the arrangement of the shapes in the reels (e.g., shape 423), such as by matching a predetermined pattern of shapes on payout lines 424a-c. However, each shape may also have a symbol (here a single digit number) associated with it, such as numbers 426 associated with shapes 423. These numbers 426 may be randomly assigned for each shape 423 at each turn, such as if there was a random number generator attached to the shape 423. Alternatively, the numbers 426 may be statically assigned to a shape 423, either permanently (as in a mechanical reel) or for a predetermined number of turns.

The determination of a secondary winning event in the arrangement 420 may be based on a series of the numerals 426 matching a fixed lucky number. The arrangement of the numerals 426 into a possible winning series may be based on existing payout lines 424a-c, or on patterns. For example, determining a potential winning number based on individual numerals 426 (or any other symbol) may involve concatenating the numerals 426 using any combination of patterns superimposed on the reels 422, including horizontal lines 424a-c, diagonal lines 427, vertical lines 428, polylines, closed shapes, etc.

Another variation of assembling dynamic symbols according to an embodiment of the invention is shown in FIG. 4G. In this example a game play area 430 includes slot reels 432 as is known in the art. Associated with each of the reels 432 are numerical indicators 434 that together form a dynamic symbol. The numbers in the indicators 434 can be randomly generated for each spin, or on the happening of some other event (e.g., bonus round, free spin, etc.). In one variation, each of the numbers 434 is generated for each spin of the reels, and the complete symbol is generated on completion of the specified number of spins or other play events. For example, in this illustration it would take 5 spins to complete the number sequence 434 and thereby determine whether or not the user wins. As with other embodiments, the symbol formed by the indicators 434 can be compared against a machine-specific and/or user-specific symbol as described herein to determine a secondary payout that is independent of payouts associated with the reels 432.

It will be appreciated that the use of lucky numbers/symbols is not limited to slot machines. In reference now to FIG. 4H, a card game 440 is shown according to an embodiment of the invention. A primary play area 442 includes a graphical representation of a card game as is known in the art, such as a five-card poker game in this example. A “lucky hand” is shown in area 444. This lucky hand 444 may be relatively fixed for each hand shown in primary play 442, and may remain fixed for a number of subsequent plays. The matching between the lucky hand 444 and the primary play hand 442 may be made based on the first deal of the hand 442, and it may be possible to allow the player to draw to try and match the lucky hand 444. As with other embodiments, the lucky hand 444 may not appear for every play of the primary game 442. For example, the lucky hand 444 may be built one card at a time for each play of the primary game 442. The comparison between the primary hand 442 and the lucky hand 444 may at least occur on the primary play event that finished the lucky hand 444. In one variation, the previous primary hands 442 that the player was dealt and/or drew into could be saved, such that a column of previously played hands appears, and each of those hands is compared to the primary hand 444, thereby increasing the odds of a match, but only if the player continues to play for the specified number of hands.

As previously described, the static or fixed symbols displayed on the gaming machines may be uniquely associated with each machine. Generally, this may involve generating a symbol for each machine of a plurality of machines based on a predetermined event. Although the symbol for each machine may be independently generated, there may be some situations (particularly where there are a large number of such machines) where two or more machines display the same symbol. Even so, the symbols may be considered to be uniquely associated with the respective machine, at least because the symbols are independently generated.

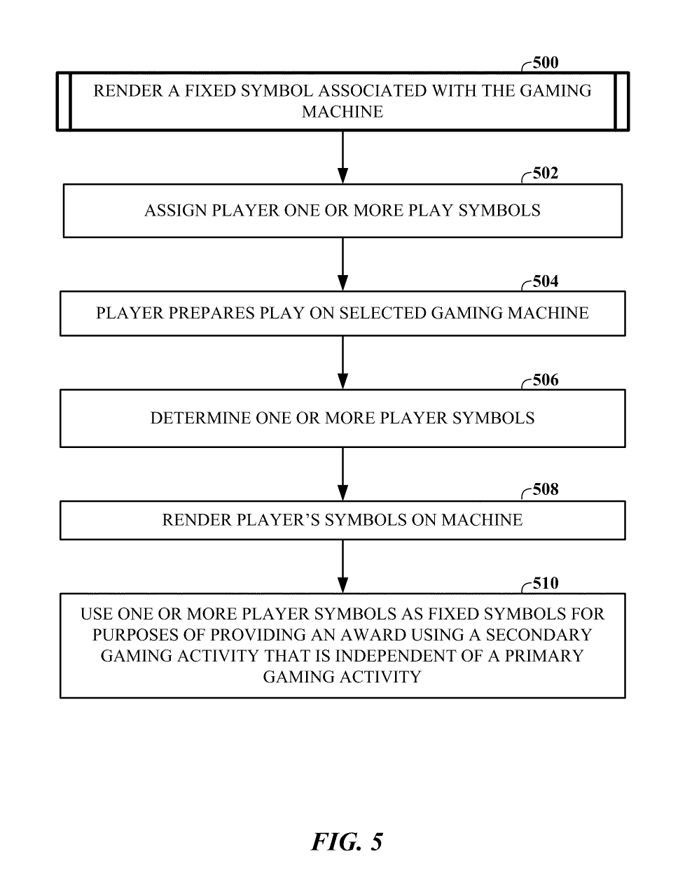

A machine may change its fixed symbol based on any combination of events such as the passage of time, number of play events, players matching the symbol during a primary gaming event, or any other happening at the machine itself or elsewhere. In some arrangements the symbols can be associated with a machine for so long as a player uses the machine. In one variation, the player may carry the same fixed symbol to each machine, and each machine thereafter presents winning opportunities based on that symbol in association with the primary events offered on the machine. Turning now to FIG. 5, a flow diagram illustrates an example procedure 500 for providing a player-portable fixed symbol according to embodiments of the invention.

First, a player is assigned 502 one or more play symbols. These symbols may be assigned 502 for use in a given location and/or for a given time period. The symbols may be assigned in any manner known in the art. For example, the player may be given the symbols as part of a hotel or casino package. In other arrangements, the symbols may be purchased and associated with an ID card, credit card, debit card, club card, or other item that facilitates wagering. The symbols may be derived from any combination or subcombination of numbers associated with the user card or ID, including random selection of numbers. In another arrangement, the user may be able to choose their own lucky number and have it recorded to a card, printout, bar code, token, network server, etc. The determination of the player's personal symbols by a gaming machine can be made using some manner of portable data storage medium. Such data storage medium may include magnetic cards, optical media, flash memory, RFID chips, beacons or radio transmitters, portable electronic devices, etc.

After the symbol(s) are assigned, the player approaches 504 a gaming machine, and the machine determines 506 the value of the one or more symbols associated with the player. For example, the symbols may be determined 506 by directly reading from a portable data storage medium carried by the player. In another arrangement, an identifier (e.g., player identity) can be read from a data storage medium carried by a player, and that identifier can be used to retrieve stored symbol from a network or similar data communications infrastructure. After the value of the symbol is determined 506, the symbol value may be displayed 508 via the machine, and the player's symbols are used 510 as fixed symbols for purposes of determining awards for secondary activities that are independent of a primary gaming activity, as described elsewhere herein.

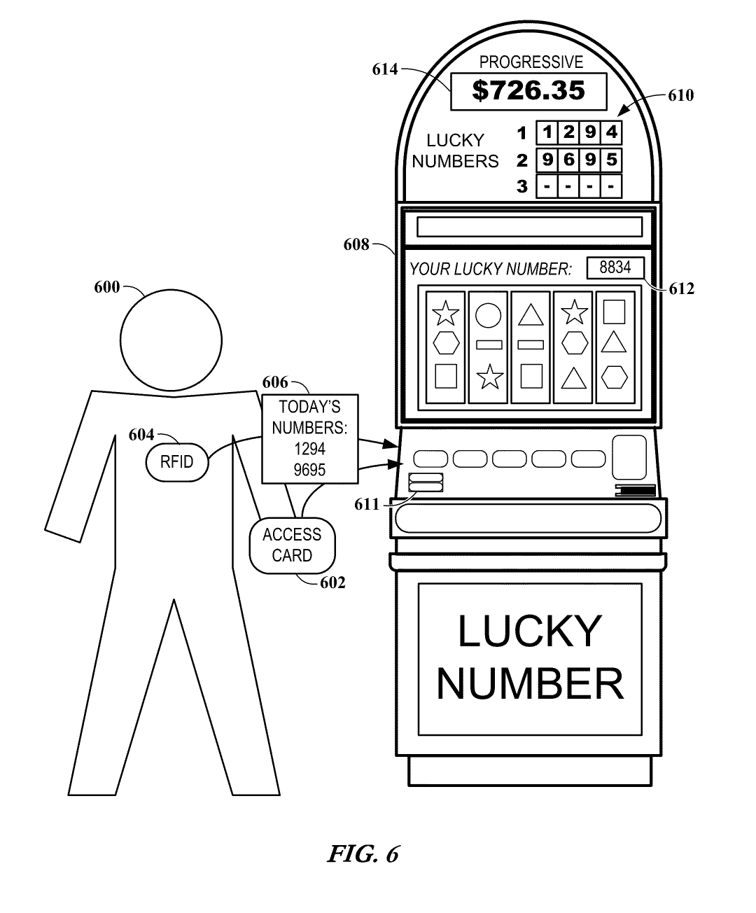

Other aspects of using player-associated symbols associated with secondary gaming events is shown in FIG. 6 according to an embodiment of the invention. A player 600 may carry some sort of tangible media that allows symbol values associated with the player 600 to be determined. Tangible media are represented in this example as an access card 602 and an RFID tag 604. The player 600 in this illustration has two symbol values 606 that may be good for a particular time period, e.g., until the end of the current day. The symbol values 606 are read from one or more of the tangible media 602, 604, when the player 600 is proximate to a gaming machine 608.

The gaming machine 608 may be configured to automatically attempt to read the symbol values 606 from the reader based purely on proximity. For example, the gaming machine 608 may be in an “attract mode,” when no play is being engaged. When the player 600 gets within a certain distance of the machine 608, the machine may present an indicator that the player's “lucky numbers” may be used in conjunction with the primary game hosted by the machine 608. This indicator may involve, among other things, the showing of the player's number on a dedicated display area 610. In other arrangements, the player's numbers may be indicated in the display area 610 only when the player 600 initiates play with the machine 608. For example, the symbols 606 may be read when the player 600 swipes the access card 602 in a card reader 611 of the gaming machine 608.

After the gaming machine 608 has determined the player's symbol values 606, the machine can display a randomly generated symbol value 612 in association with the player 600 completing gaming events on the machine 608 (e.g., rolls, spins, hands, deals, etc., associated with the primary game). This symbol value 612 can be compared against the one or more fixed symbol values 610 that are displayed. This comparison may result in the player winning if the dynamic symbol value 612 matches one of the fixed values 610 according to some predetermined criterion. The amount of the award for such a win may also be displayed, as shown using pay out indicator 614. This payout may be calculated using a fixed pay table, or be progressively determined based on events associated with the machine 608 and/or the player 600, or any combination thereof. For example, a centralized entity may track the player's interaction with games that include this feature, and increase the indicated win value 614 in response to the player's continued play, even when the play is distributed among different gaming machines. As in previous examples, the indicator 614 may show a single award value, or multiple award values, such as to provide awards for matching sub-portions between the fixed and dynamic symbols 610, 612.

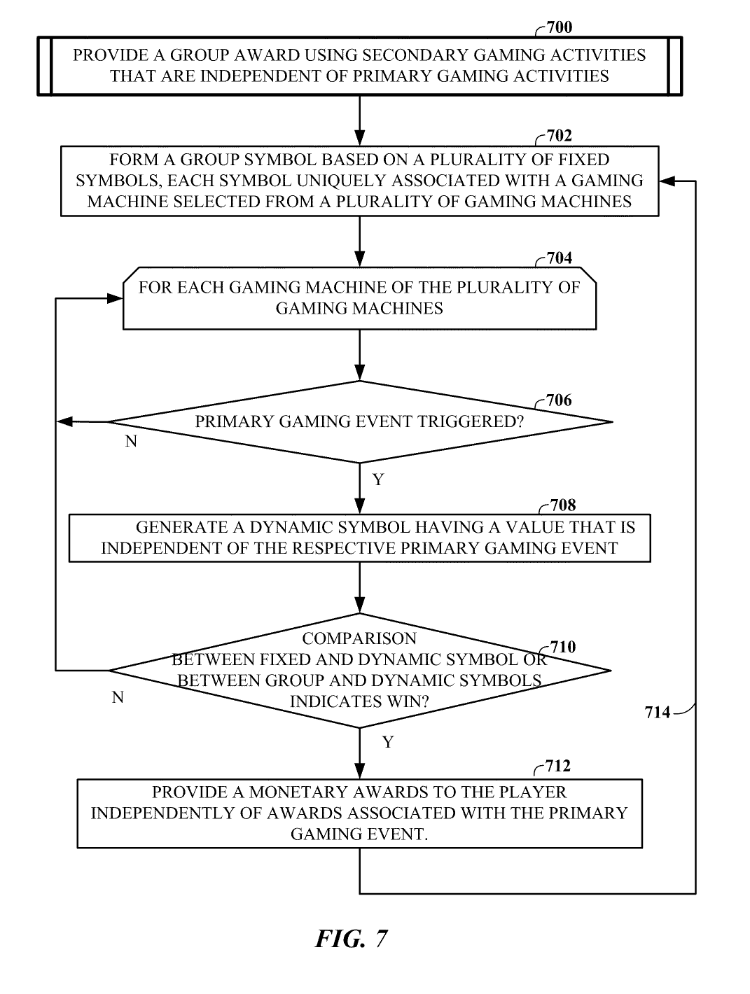

As described above, a gaming machine has one or more fixed symbols associated with the machine for purposes of providing a secondary gaming activity that is peripheral to the primary activity on the machine. Each fixed symbol is intended to be independently associated with each gaming machine, and this usually means that the symbols will be unique. Although this assignment of symbols is intended to provide a unique, secondary gaming experience for each machine, additional features may be added that to combine these independently associated symbols to provide a group gaming experience. In reference now to FIG. 7, an example procedure 700 is illustrated for providing a group gaming experience using secondary gaming activities according to embodiments of the invention.

In the procedure 700, a group symbol is formed 702 based on a plurality of symbols that are each associated with a different gaming machine. Forming 702 the group symbol may include combining all or parts of each of the plurality of symbols using operations such as concatenation, mathematical operations logical operations, geometric combinations or operations, etc. After the group symbol is formed 702 each of the individual gaming machines can use both the local fixed symbol and the group symbol for determining a win, as described in blocks 704, 706, 708, 710, and 712. These steps are analogous to those described in relation to FIG. 1, except that each machine tests 710 against the group symbol as well as the local, fixed symbol. The procedure 700 may also require that the group symbol be regenerated if any winners are determined 710, 712, as indicated by path 714.

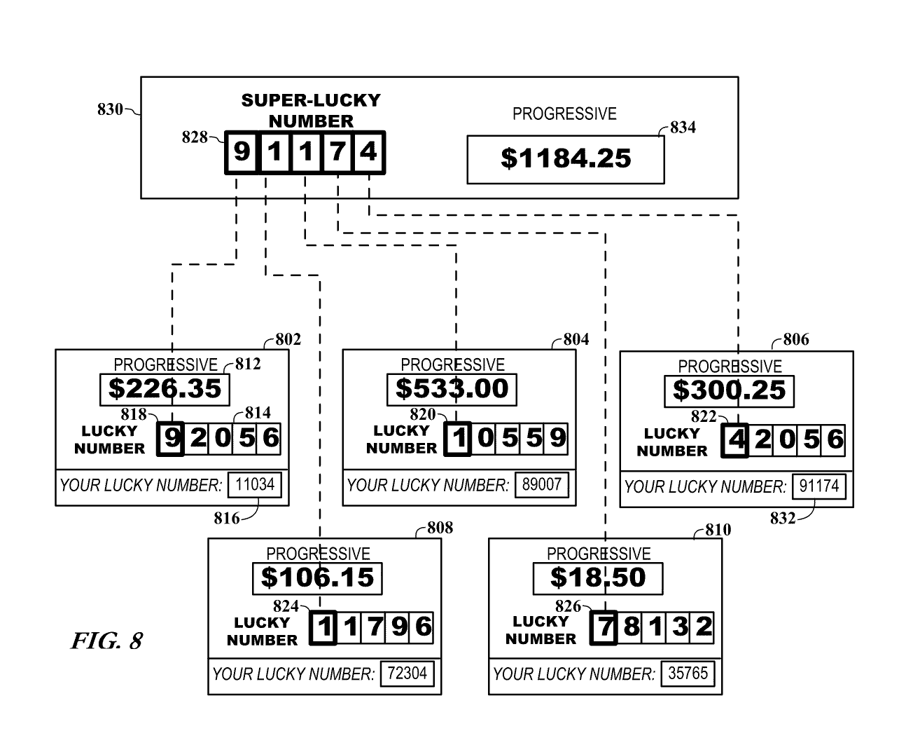

In reference now to FIG. 8, an implementation of a group symbol arrangement is illustrated according to an embodiment of the invention. Generally, blocks 802, 804, 806, 808, 810 represent any number of individual gaming machines, wherein each gaming machine may be configured to offer a different primary gaming activity. However, each gaming machine 802, 804, 806, 808, 810 may include a visually and operationally consistent interface for providing a “lucky number” pay out independently of the primary activity. As shown in machine 802, this interface may include a payout indicator 812, a fixed symbol 814, and a dynamic symbol 816. In addition, one element 818 of the fixed symbol 814 is highlighted, and elements 820, 822, 824, and 826 are similarly highlighted respectively in the displays of machines 804, 806, 808, 810.

The highlighted symbol elements 818, 820, 822, 824, and 826 are combined to form a group symbol 828. This group symbol 828 may be visible to all players of the gaming machines 802, 804, 806, 808, 810, such as by being shown in a large display 830. In this example, the group symbol 828 is formed by concatenating the first element (e.g., digit) of the fixed symbols of the respective machines 802, 804, 806, 808, 810. The use of the first element in this example is arbitrary; any one or more symbol elements from any participating gaming machine may be used to form the group symbol 828. In other arrangements, a random element of the fixed symbol may be selected. In still other arrangements, all of the fixed symbols could be combined into a resulting symbol such as a grid (e.g., grid 412 in FIG. 4D). Additionally, the fixed symbols of machines 802, 804, 806, 808, 810 can be used to form more than one group symbol. For example, the second element of each fixed symbol could be concatenated to form a second group symbol, the third element of each fixed symbol could be concatenated to form a third group symbol, etc.

If a player of any of gaming machines 802, 804, 806, 808, 810 matches a dynamic symbol of the player's respective machine with the group symbol 828, then that player will win, even the player fails to match the local symbol or fails to win at the primary gaming event that generated the winning symbol. In the illustrated example, the player of machine 806 has generated a dynamic symbol 832 that matches the group symbol 828, and therefore that player will win whatever award is associated with the group symbol. The amount this player wins is indicated in the large display 830 by way of indicator 834. In this example, the winning amount 834 for matching the group symbol 828 is equal to the sum of the individual awards associated with the fixed symbols of each machine 802, 804, 806, 808, 810, although other payout arrangements are possible.

Note that if an individual player wins the group award 834, the individual awards as indicated (e.g., via indicator 812) on each of the machines 802, 804, 806, 808, 810 may reset to zero. Also, after such a winning event, it may be desirable to change the value of the winning symbol 828. This changing of the winning symbol 828 may be accomplished, for example, by moving highlighted elements 818, 820, 822, 824, and 826 in some predetermined fashion (e.g., each element is shifted left or right one space, or each element is randomly reassigned). It will be appreciated that the value of the group symbol 828 may change due to other events occurring at one or all of gaming machines 802, 804, 806, 808, 810. For example, a matching of a dynamic symbol with a fixed symbol of one machine may cause the fixed symbol of that machine to change, thus causing at least one element of the group symbol 828 to change accordingly. The group symbol 828 may also change automatically independent of happenings at the machines 802, 804, 806, 808, 810 (e.g., based on time, location, player identities, etc.).

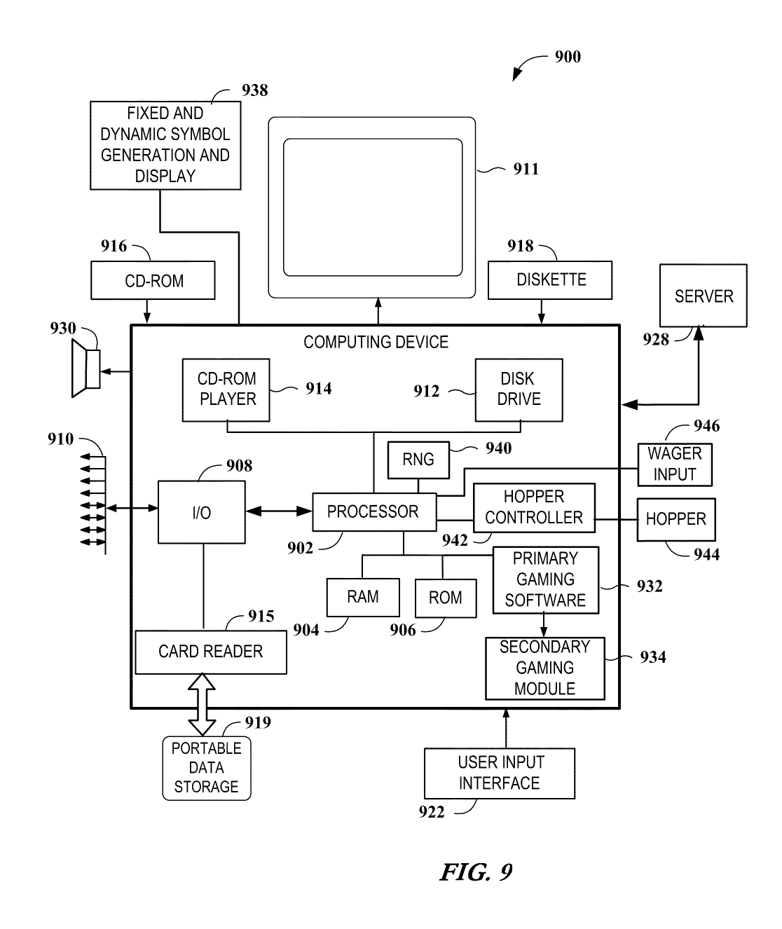

As may now be readily understood, one or more devices may be programmed to play various embodiments of the invention. The present invention may be implemented as a casino gaming machine such as a slot machine or other special purpose gaming kiosk as described in FIGS. 2, 3, 6, and 8, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 9.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 900 of FIG. 9 is an example computing structure that can be used in connection with such electronic gaming machines, computers, or other computer-implemented devices to carry out operations of the present invention.

The example computing arrangement 900 suitable for performing the gaming functions in accordance with the present invention typically includes a central processor (CPU) 902 coupled to random access memory (RAM) 904 and some variation of read-only memory (ROM) 906. The ROM 906 may also represent other types of storage media to store programs, such as programmable ROM (PROM), erasable PROM (EPROM), etc. The processor 902 may communicate with other internal and external components through input/output (I/O) circuitry 908 and bussing 910, to provide control signals, communication signals, and the like.

The computing arrangement 900 may also include one or more data storage devices, including hard and floppy disk drives 912, CD-ROM drives 914, card reader 915, and other hardware capable of reading and/or storing information such as DVD, etc. In one embodiment, software for carrying out the operations in accordance with the present invention may be stored and distributed on a CD-ROM 916, diskette 918, access card 919, or other form of media capable of portably storing information. These storage media may be inserted into, and read by, devices such as the CD-ROM drive 914, the disk drive 912, card reader 915, etc. The software may also be transmitted to the computing arrangement 900 via data signals, such as being downloaded electronically via a network, such as the Internet. Further, as previously described, the software for carrying out the functions associated with the present invention may alternatively be stored in internal memory/storage of the computing device 900, such as in the ROM 906.

The computing arrangement 900 is coupled to the display 911, which represents a display on which the gaming activities in accordance with the invention are presented. The display 911 represents the “presentation” of the video information in accordance with the invention, and may be any type of known display or presentation screen, such as LCD displays, plasma display, cathode ray tubes (CRT), digital light processing (DLP), liquid crystal on silicon (LCOS), etc. Where the computing device 900 represents a stand-alone or networked computer, the display 911 may represent a standard computer terminal or display capable of displaying multiple windows, frames, etc. Where the computing device is embedded within an electronic gaming machine, the display 911 corresponds to the display screen of the gaming machine/kiosk. A user input interface 922 such as a mouse, keyboard/keypad, microphone, touch pad, trackball, joystick, touch screen, voice-recognition system, etc. may be provided. The display 911 may also act as a user input device, e.g., where the display 911 is a touchscreen device.

Chance-based gaming systems such as slot machines, in which the present invention is applicable, are governed by random numbers and processors, as facilitated by a random number generator (RNG). In particular, the fixed and dynamic symbols generated as part of a secondary gaming activity may be produced using one or more RNGs. RNGs are known in the art, and may be implemented using hardware, software operable in connection with the processor 902, or some combination of hardware and software. The present invention is operable using any known RNG, and may be integrally programmed as part of the processor 902 operation, or alternatively may be a separate RNG controller 940.

The computing arrangement 900 may be connected to other computing devices or gaming machines, such as via a network. The computing arrangement 900 may be connected to a network server 928 in an intranet or local network configuration. The computer may further be part of a larger network configuration as in a global area network (GAN) such as the Internet. In such a case, the computer may have access to one or more web servers via the Internet.

Among other functions, the computing arrangement 900 provides an interactive experience to players via input interface 922 and output devices, such as the display 911, speaker 930, etc. These experiences are generally controlled by gaming software 932 that controls a primary gaming activity of the computing arrangement 900. The gaming software 932 may be temporarily loaded into RAM 904, and may be stored locally using any combination of ROM 906, drives 912, or media player 914. The primary gaming software 932 may also be accessed remotely, such as via the server 928 or the Internet.

The primary gaming software 932 in a computing arrangement 900 according to embodiments of the present invention may provide any manner of gaming experience known in the art, and the present invention does not depend on any specific type of primary gaming software 932. The primary gaming software 932 may, however, provide indications of primary gaming events for use by a secondary gaming module 934. The secondary gaming module 934 may control specialized hardware 938 used for generating and/or displaying fixed and/or random symbols associated with the computing arrangement 900. Generally, the hardware 938 displays a fixed symbol for a predetermined amount of time, and may display additional data in conjunction with the fixed symbol, such as payoff amounts, win notifications, etc. The secondary gaming module 934 may also cause the hardware 938 to display dynamic symbol data in conjunction with events detected via the primary gaming software 932. In other arrangements, the dynamic symbols may be displayed integrally on the primary display 911 along with graphics of the primary gaming activity 932.

The secondary gaming module 934 may also interact with components of the computing arrangement depending on the particular features employed. For example, where a group of machines combines symbols to provide for a possibility for members of a group to match a common symbol, the secondary gaming module 934 may communicate over a network with components such as the gaming server 928. In arrangements where player-specific data is used by the secondary gaming module 934, the module 934 may interact with the user input interface 922, card reader 915, and any other hardware (e.g., RFID reader) in order to gather the needed user data. This data may include the value of player-specific symbols that are shown in the display hardware 938 and used to determine whether the player has won. This data may also include player identifiers that can be used to obtain the symbols, such as from the server 928, database (not shown) or other networked or remotely located data processing element.

Other components directed to gaming machine implementations include manners of gaming participant payment, and gaming machine payout. For example, a gaming machine including the computing arrangement 900 may also include a hopper controller 942 to determine the amount of payout to be provided to the participant. The hopper controller may be integrally implemented with the processor 902, or alternatively as a separate hopper controller 942. A hopper 944 may also be provided in gaming machine embodiments, where the hopper serves as the mechanism holding the coins/tokens of the machine. The wager input module 946 represents any mechanism for accepting coins, tokens, coupons, bills, electronic fund transfer (EFT), tickets, credit cards, smart cards, membership cards, etc., for which a participant inputs a wager amount. It will be appreciated that both the primary gaming software 932 and secondary gaming module 934 may be able to control payouts via the hopper 944 and controller 942 for independently determined payout events.

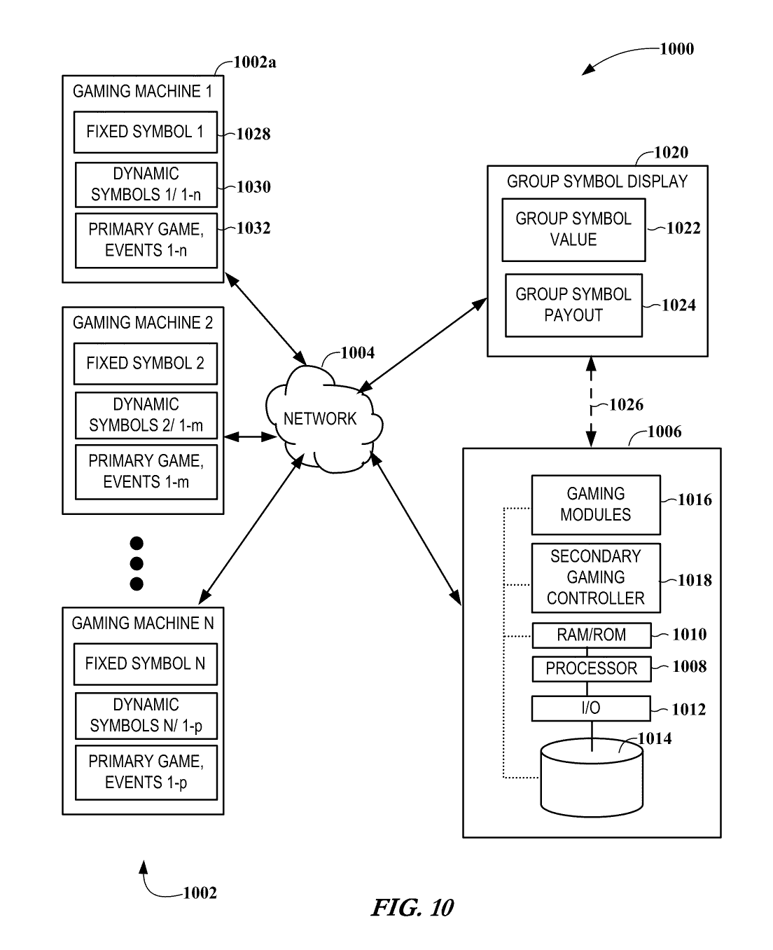

The computing arrangement 900 may be implemented as a stand-alone gaming machine, such as where all of the functionality is contained within a single apparatus. In other arrangements, the computing arrangement 900 may be implemented as a system of computers, generally coupled together by a network. A more particular example of such a system 1000 according to an embodiment of the invention is shown in FIG. 10. The system 1000 is capable of supporting a plurality of gaming machines 1002 that are coupled together via one or more networks 1004. The system 1000 includes a server element 1006 configured as a centrally accessible network entity that may support gaming activities, including the provision of primary and secondary games, and support/coordination of secondary gaming activities between two or more machines 1002.

The server 1006 may include any combination of apparatuses known in the art. The server 1006 may be implemented as a single computing device, or as a collection of computing devices. The server 1006 generally includes one or more processors 1008, volatile and non-volatile memory 1010, I/O circuitry 1012, and magnetic or optical data storage 1014. The server 1006 may also control some aspects of the primary gaming activities hosted on each of the gaming machines 1002. This is represented by gaming modules 1016. The gaming modules 1016 may include libraries or other executable images that are compatible with the processing hardware on the gaming machines 1002. In such an arrangement, the modules 1016 may be uploaded to the gaming machines 1002 at run-time and/or boot-time. In other implementations, the gaming modules 1016 may execute on the server 1006, and the gaming machines 1002 are configured acting as network-coupled input-output devices. In this latter arrangement, the gaming machines 1002 act as terminal devices, and may be configured to operate without any onboard disk storage or operating systems.

The server 1006 may also include a secondary gaming controller 1018 that may centrally control some aspects of the secondary gaming activities on the gaming machines 1002, in particular those secondary activities dealing with payouts based on fixed and dynamic symbols. For example, the secondary gaming controller 1018 may signal to one or more of the gaming machines 1002 to change the value of the fixed symbol due to some server-detected event. The secondary gaming controller 1018 may generate some or all of the fixed and/or dynamic symbols used by the individual machines 1002. Where the machines 1002 themselves generate the symbols, the secondary gaming controller 1018 may gather symbol data from the machines 1002 for purposes of controlling a group symbol display 1020. The data gathered by the server 1006 may include symbol data used to form and display a group symbol 1022, and projected payout data of the machines 1002 that is used to calculate and render a cumulative projected payout amount 1024. The group symbol display 1020 may include its own processor and receive instructions via the network 1004, or be directly coupled to some other network entity, such as the server 1006 as optionally indicated by path 1026.

The secondary gaming controller 1018 may also assist the gaming machines 1002 in other tasks, such as in the identifying of player-specific symbol values. For example, the player may have a data storage device or use some other form of positive identification (e.g., passwords, biometrics, etc.). Based on authentication of this data, the server 1006 (or some other element) may be able to provide the appropriate machine 1002 with fixed symbols associated with the player. In some arrangements, the secondary gaming controller 1018 may gather detailed data as to the status and play events in the machines 1002. As shown in relation to gaming machine 1002a, such data may include, but is not limited to, the value of individual fixed symbols 1028, the value of each dynamic symbol 1030 that is generated in response to primary gaming events, and data related to the primary gaming events 1032 themselves. This data may be used for multiple purposes, including controlling and managing multi-player interaction with a group symbol embodiment, logging, tracking reliability, tamper detection, etc.

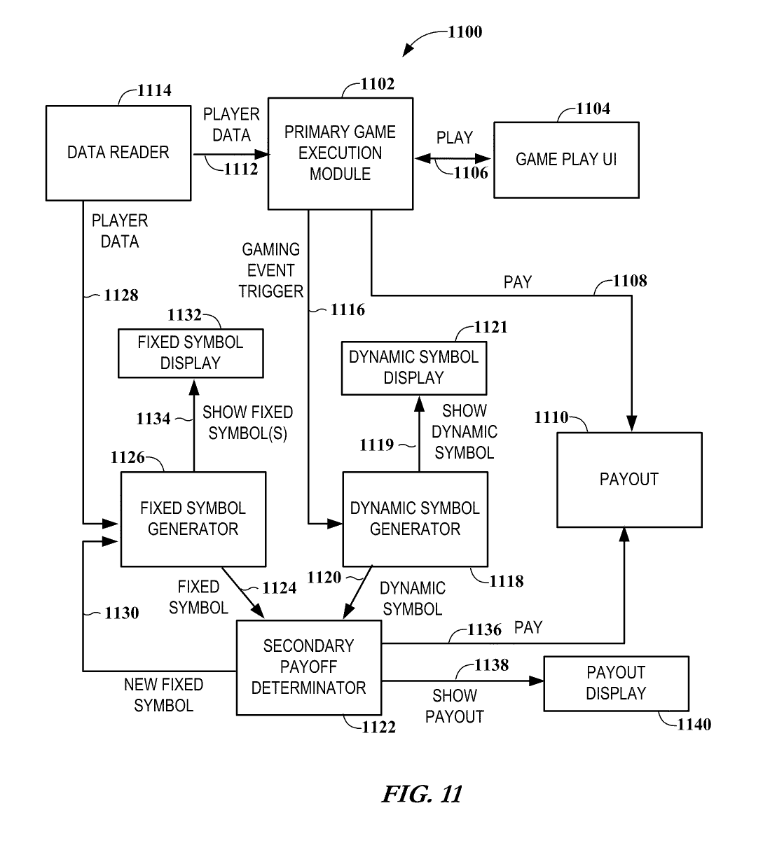

It will be appreciated that the gaming functionality described herein may be implemented on any combination of hardware and software, as well as any combination of standalone apparatus and networked systems. A more particular description of the functionality according to an embodiment of the invention is shown in the software component diagram 1100 in FIG. 11. These components 1100 may be implemented as a single executable running on a single machine, or may be multiple processes/threads that are distributed over a local-area, wide-area, or global-area network.

The components 1100 can be roughly divided into two general functional areas. One of these functional areas involves the primary gaming activity, as represented by the primary game execution module 1102 and game play user interface (UI) 1104. These modules 1102, 1104 generally interact 1106 to provide the experience of whatever game the machine is configured to play. This game play 1106 may also result in the triggering 1108 of a payout via payout module 1110. The payout module 1110 may include interfaces to hardware (e.g., coin hopper, software, and/or network components (e.g., remote secure credit transactions). The game execution module 1102 may also receive player specific data 1112 via a data reader 1114 (e.g., touchscreen, card reader, RFID reader, etc.) in order to tailor the game to a specific player, track the player's credits, etc.

The second general functional area relates to the secondary gaming activities, in particular in providing a player a change to win independently of the primary gaming activity. These secondary win opportunities may be triggered 1116 via the primary game execution module 1102. A dynamic symbol generator module 1118 receives these triggers 1116, and in response generates dynamic symbols 1120 according to the parameters of the gaming machine. Typically, the dynamic symbol generator 1116 will generate the symbols using random or pseudo-random number generator algorithms and/or RNG hardware as is known in the art. The dynamic symbol module 1120 may also display 1119 the dynamic symbols via a dynamic symbol display module 1121.

A secondary payoff determinator 1122 receives the dynamic symbols 1120 from the generator 1118 and compares them to a fixed symbol 1124 communicated from a fixed symbol generator 1126. The fixed symbol generator 1126 may generate the value of the fixed symbol 1124 based on a number of factors. The fixed symbol 1124 may be associated with a particular player, as indicated by player data 1128 received from the data reader 1114. The fixed symbol 1124 may be generated and re-generated by the fixed symbol generator 1126 by internally or externally communicated events, including a win, as shown by signal 1130 received from payoff determinator 1122. Other events that may cause the fixed symbol generator 1126 to generate or regenerate the fixed symbol 1124 include the passage of time, signals from a network server or controller (not shown), player identity, environmental factors, random regeneration, etc. The fixed symbol generator 1126 may also cause a fixed symbol display 1132 to display the current value of the fixed symbol, as indicated by signal 1134.

In response to receiving the fixed symbol 1124 and dynamic symbol 1120, the secondary payoff determinator 1122 makes a determination of whether or not the dynamic symbol 1120 results in a win. This determination may involve comparison, mathematical operations, logical operations, or other data operations known in the art. If a win is determined, this results in a payout 1136 being signaled to the payout interface 1110. The payout interface 1110 may handle the payout 1136 in the same way or differently than payouts 1108 of the primary gaming event. For example, the primary event payout 1108 may be in the form of cash or cash equivalent, but the secondary payout 1136 may be in a form such as non-redeemable player credits, coupons, discounts, etc. Finally, the secondary payoff determinator 1122 may uniquely signal 1138 this payout 1136 a payout display 1140 so that the player can be informed of the payout, but do so without confusing the secondary payout 1136 with a win associated with the primary gaming activity 1102.

The foregoing description of the exemplary embodiments of the invention has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of the gaming activities. It is intended that the scope of the invention be limited not with this detailed description, but rather determined from the claims appended hereto.

What is claimed is:

1. A method of providing a gaming experience to a player, comprising:
detecting a plurality of events associated with a primary gaming activity of a gaming machine;
generating, in response to at least one of the events, a dynamic symbol having a value that is independent of the respective primary gaming event; and
providing a monetary award to the player based on a value of at least one of the dynamic symbols meeting a predetermined criterion, wherein the provision of the monetary award is determined independently of outcomes of the events of the primary gaming activity.

2. The method of claim 1, further comprising rendering, during the plurality of events, a fixed symbol uniquely associated with the gaming machine, and wherein providing the monetary award is based on comparing the at least one of the dynamic symbols with the fixed symbol.

3. The method of claim 2, wherein the comparison of the at least one of the dynamic symbols with the fixed symbol comprises determining matching values of individual elements of the at least one of the dynamic symbols with individual elements of the fixed symbol.

4. The method of claim 3, wherein the comparison of the at least one of the dynamic symbols with the fixed symbol comprises determining matching sequences of the individual elements of the at least one of the dynamic symbols with sequences of the individual elements of the fixed symbol.

5. The method of claim 2, wherein providing the monetary award to the player comprises determining two or more potential awards associated with the comparison of the at least one dynamic symbol with the fixed symbol, wherein values of the two or more projected awards are determined based on degrees of similarity between the at least one dynamic symbol and the fixed symbol.

6. The method of claim 2, further comprising changing a value of the fixed symbol based on the provision of the monetary award to the player.

7. The method of claim 2, further comprising setting the value of the fixed symbol based on an identity of the player.

8. The method of claim 1, further comprising rendering a value of a projected monetary award associated with the value of the at least one of the dynamic symbols meeting the predetermined criterion.

9. The method of claim 8, further comprising incrementing the value of the projected monetary award based on successive events that result in no monetary awards being provided to the player.

10. The method of claim 1, wherein the value of the monetary award is determined based on the number of successive events that result in no monetary awards being provided to the player.

11. The method of claim 1, wherein generating the dynamic symbol in response to at least one of the events comprises generating portions of the dynamic symbol in response subsequently occurring events of the primary gaming activity, and wherein determining whether the at least one of the dynamic symbols meets the predetermined criterion occurs after a sufficient number of the subsequently occurring events have taken place in order to form the at least one dynamic symbol.

12. A method of providing a gaming experience to players of a plurality of gaming machines, each of the gaming machines offering a primary gaming activity, the method comprising:
uniquely associating each of the gaming machines with a fixed symbol;
determining a group symbol based on the fixed symbols of the gaming machines; and
for each of the gaming machines,
detecting events associated with the primary gaming activity of the gaming machine;
generating, in response at least one of the events, a dynamic symbol having a value that is independent of the respective event;
providing a monetary award to the player of the gaming machine based on a comparison of one of the dynamic symbols with the group symbol, wherein the provision of the monetary award is determined independently of outcomes of the primary gaming activity of the machine.

13. The method of claim 12, further comprising, for each of the gaming machines providing a monetary award to the player of the gaming machine based on a value of one of the dynamic symbols meeting a predetermined criterion.

14. The method of claim 13, wherein for at least one of the gaming machines, providing the monetary award based on the value of one of the dynamic symbol comprises providing the monetary award based comparing one of the dynamic symbols with the fixed symbol uniquely associated with the at least one gaming machine.

15. The method of claim 12, wherein uniquely associating each of the gaming machines with a fixed symbol comprises setting the value of the fixed symbol for each machine based on an identity of the player of each machine.

16. A casino gaming apparatus, comprising:
a processor;
a human input and output coupled to the processor;
a primary gaming module that causes the processor to provide player access to a primary gaming activity via the human input and output;
a secondary gaming module that causes the processor to,
generate, in response to a plurality of events of the primary gaming activity,
a dynamic symbol having a value that is independent of the respective event;
render the dynamic symbols via the human input and output;
determine a secondary winning event based the value of one of the dynamic symbols meeting a predetermined criterion, wherein the secondary winning event is independent of outcomes of the primary gaming activity; and
provide a monetary award to the player based on the secondary winning event.

17. The gaming apparatus of claim 16, wherein the secondary gaming module further causes the processor to:
generate a fixed symbol uniquely associated with the apparatus;
render the fixed symbol via the human input and output; and
wherein the predetermined criterion of the secondary gaming module comprises a comparison of the fixed symbol with the one of the dynamic symbols.

18. The gaming apparatus of claim 17, wherein the predetermined criterion comprises matching values of individual elements of one of the dynamic symbols with individual elements of the fixed symbol.

19. The gaming apparatus of claim 18, the predetermined criterion comprises matching sequences of the individual elements of one of the dynamic symbols with sequences of the individual elements of the fixed symbol.

20. The gaming apparatus of claim 17, wherein the secondary gaming module causes the processor to change a value of the fixed symbol based on the provision of the monetary award to the player.

21. The gaming apparatus of claim 17, further comprising a player identity module that causes the processor to detect an identity of a player, and further causes the secondary gaming module to set a value of the fixed symbol based on the identity of the player.

22. The gaming apparatus of claim 16, wherein the secondary gaming module causes the rendering device to render a projected value of the monetary award.

23. The gaming apparatus of claim 22, wherein the secondary gaming module causes the rendering device to increment the projected value of the monetary based on successive events of the primary gaming activity during which no secondary winning events are determined by the secondary gaming module.

24. The gaming apparatus of claim 16, wherein the secondary gaming module causes the processor to:
generate portions of the dynamic symbol in response subsequently occurring events of the primary gaming activity; and
determine whether the at least one of the dynamic symbols meets the predetermined criterion occurs after a sufficient number of the subsequently occurring events have taken place in order to form the at least one dynamic symbol.

25. A computer-readable medium having computer-executable instructions stored thereon and executable by a processing system for performing steps comprising:
detecting a plurality of events associated with a primary gaming activity of a gaming machine;
generating, in response to the events, a dynamic symbol having a value that is independent of the respective primary gaming event; and
providing a monetary award to the player based on a value of at least one of the dynamic symbols meeting a predetermined criterion, wherein the provision of the monetary award is determined independently of outcomes of the events of the primary gaming activity.

26. The computer-readable medium of claim 25, wherein the steps further comprise rendering, during the plurality of events, a fixed symbol uniquely associated with the gaming machine, and wherein providing the monetary award is based on comparing the at least one of the dynamic symbols with the fixed symbol.

27. The computer-readable medium of claim 26, wherein the steps further comprise setting the value of the fixed symbol based on an identity of the player.

28. A system comprising:
a plurality of gaming machines each uniquely associated with a fixed symbol, each of the gaming machines comprising,
a human input and output capable of providing player access to a primary gaming activity of the machine;
a processor coupled to the human input and output;
a primary gaming module that causes the processor to facilitate, via the human input and output, player interaction with the primary gaming activity; and
a secondary gaming module that causes the processor to generate, in response to at least one of a plurality of events of the primary gaming activity, a dynamic symbol that is independent of the respective event; and
a group display apparatus coupled to the plurality of gaming machines, the group display apparatus comprising,
a display;
a processor coupled to the display; and
a memory having instructions that cause the processor to,
form a group symbol based on the fixed symbols of the plurality of gaming machines;
display the group symbol via the display; and
wherein the system is further configured to provide a monetary award to a player of a gaming machine selected from the plurality of gaming machines based on a comparison of one of the dynamic symbols of the selected gaming machine with the group symbol.

29. The system of claim 28, where the secondary gaming modules of at least one of the gaming machines cause the processor of the at least one gaming machine to:
determine a secondary winning event based the value of one of the dynamic symbols that meets a predetermined criterion, wherein the secondary winning event is independent of outcomes of the primary gaming events; and
provide a local monetary award to the player based on the secondary winning event, wherein a value of the local monetary award is determined independently of awards associated with the primary gaming activity of the at least one gaming machine.

30. The system of claim 28, wherein the fixed symbols of the plurality of gaming machines are uniquely associated with the each gaming machine based on the identity of the player of each gaming machine.
